(19) United States
(12) Patent Application Publication
(10) Pub. No.: US 2023/0242311 A1
(43) Pub. Date: Aug. 3, 2023

(54) Marble-Sealed Containers with One Hand Activation and Methods of Use

(71) Applicant: EFFRVS LLC, Geneva, IL (US)

(72) Inventor: Vladimir V. Starkov, Geneva, IL (US)

(21) Appl. No.: 18/162,839

(22) Filed: Feb. 1, 2023

Related U.S. Application Data
(60) Provisional application No. 63/305,914, filed on Feb. 2, 2022.

(51) Int. Cl. B65D 51/28; B65D 39/06; B65D 41/04; A23L 2/56; A23L 2/58

(52) U.S. Cl. CPC B65D 51/2885; B65D 39/06; B65D 41/04; A23L 2/56; A23L 2/58

(57) ABSTRACT

A container can include a container body with a neck, a lid, a marble positioned in the neck within one or more flexible flanges, a spring, and/or a flexible detent. The neck can include an opening for dispensing content stored within the container. In some embodiments, the container contains a liquid. In some embodiments, the container includes a non-dissolvable membrane that extends from the lower end of the flexible flange(s) below the marble. In some embodiments, at least a portion of the marble is dissolvable in the liquid stored in the container body. In some embodiments, upon the marble dissolving, the liquid content changes color, flavor and/or nutrients are released into the liquid content.

### CROSS-REFERENCE TO RELATED APPLICATION

This application claims priority benefits from U.S. provisional patent application Ser. No. 63/305,914 filed on Feb. 2, 2022, entitled “Marble-Sealed Container with One Hand Activation”. The '914 application is hereby incorporated by reference herein in its entirety.

### FIELD OF THE INVENTION

The present subject matter relates generally to a marble-sealed container used for storing beverages or other liquids, for example. In some embodiments, the marble-sealed container utilizes a closing mechanism, which includes a solid sphere, for example a marble, that is held against a flexible seal affixed to the container. In some embodiments, the marble and flexible seal provide for a leak-proof seal.

The “Codd bottle” was originally designed by Hiram Codd to enclose a marble and a rubber washer/gasket in the neck. The bottles were filled upside down, and the pressure of the gas (e.g., carbonation) in the bottle forced the marble against the washer, sealing in the carbonation. The bottle was pinched into a special shape to provide a chamber into which the marble was pushed after opening of the bottle, which prevents the marble from blocking the neck as the drink was poured or drank.

To open a conventional Codd bottle, a sturdy surface and substantial pressure is required in order to remove the marble by force. As such, Codd bottles are particularly difficult to open for people on the go, elderly, children, and/or people with disabilities. Additionally, Codd bottles cannot be re-closed after opening.

Accordingly, there is a need for a marble-sealed container that is easier to open, re-close and/or is enabled for use with new types of beverages. Examples of marble-sealed containers can be found in U.S. Pat. No. 10,450,110 and U.S. Pat. No. 11,001,416, which are herein incorporated by reference in their entireties.

The present disclosure pertains to a technology that improves upon previous sealed containers in the art. In some embodiments, the present disclosure involves a marble-sealed container that is easily opened and closed with minimal, or at least reduced effort. In at least some embodiments, the disclosed invention enables opening and closing motions of the marble-sealed container with the use of just one hand when necessary.

### SUMMARY OF THE INVENTION

In some embodiments, a container can include a container body with a container neck with an opening; a lid connected to the container body at the opening; at least one flexible flange positioned within the container neck; a marble positioned in the container neck within the flexible flange(s); a spring positioned inside the container neck above the marble; and/or a flexible detent attached to an underside of the lid. In at least some embodiments, the neck includes an opening for dispensing content stored within the container.

In some embodiments, multiple flexible flanges are used. In some embodiments, the flange is a circular flange.

In some embodiments, the lid is configured to move between an open position and a closed position. In some embodiments, the flexible flange(s) prevent(s) movement of the marble. In some embodiments, the spring moves between a compressed state and an uncompressed state. In some embodiments, the flexible detent is configured to retain the spring in the compressed position. In some embodiments, when the lid moves from the closed position to the open position, the flexible detent releases the spring to the uncompressed state. In some embodiments, the flexible detent positioned on the underside of the lid.

In some embodiments, the flexible flange(s) extend(s) downwardly from the opening in the neck. and configured to retain the spring in a compressed state when the lid is in the closed position.

In some embodiments, the container includes a cap. In some embodiments, the cap includes a lid rotatable about an eyelet, wherein the lid is configured to move between an open position and a closed position. In some embodiments, a spring is positioned on the underside of the cap above the marble.

In some embodiments, the container contains a liquid.

In some embodiments, the container includes a non-dissolvable membrane that extends from the lower end(s) of the flexible flange(s) below the marble.

In some embodiments, at least a portion of the marble is dissolvable in the liquid stored in the container body.

In some embodiments, at least a portion of the marble is covered with a non-dissolvable membrane.

In some embodiments, upon the marble dissolving, the liquid content changes color.

In some embodiments, upon the marble dissolving, the liquid content changes flavor.

In some embodiments, upon the marble dissolving, nutrients are released into the liquid content.

In some embodiments, the container includes a movable grid positioned above the marble and below the lid, wherein the movable grid prevents, or at least deters, the removal of the marble from the container.

In some embodiments, the container includes a fixed grid positioned above the marble and below the lid, wherein the fixed grid prevents, or at least deters, removal of the marble from the container.

### BRIEF DESCRIPTION OF THE DRAWINGS

FIG. 1 is a cross-sectional side view of an embodiment of a marble-sealed container.

FIG. 2 is a cross-sectional side view of the marble-sealed container of FIG. 1 illustrating an opening movement of the marble-sealed container.

FIG. 3 is a cross-sectional side view of another embodiment of a marble-sealed container.

FIG. 4 is a cross-sectional side view of a marble-sealed container of FIG. 3 illustrating an opening movement of the marble-sealed container.

### DETAILED DESCRIPTION OF ILLUSTRATIVE EMBODIMENT(S)

The drawing figures depict one or more implementations in accord with the present concepts, by way of example only, not by way of limitations. In the figures, like reference numerals refer to the same or similar elements.

At least part of this disclosure is directed to marble-sealed containers that preserve the marble's features yet allows for easy opening, potentially with one hand, re-closing, and/or unobstructed pouring of the content stored in the marble-sealed container. In some embodiments, a mobile application can be used to improve consumer engagement with a marble-sealed container.

In some embodiments, one advantage of at least some of the disclosed containers is that they allow a user to easily open a marble-sealed container, potentially using just one hand. Therefore, in at least some embodiments, the container is easily opened by children, elders, and/or people with disabilities.

In at least some embodiments, the container can be re-closed after opening. In at least some embodiments, the appeals to users on the go.

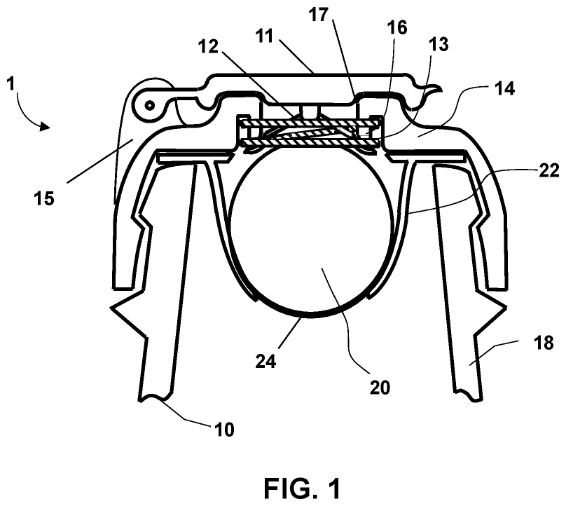

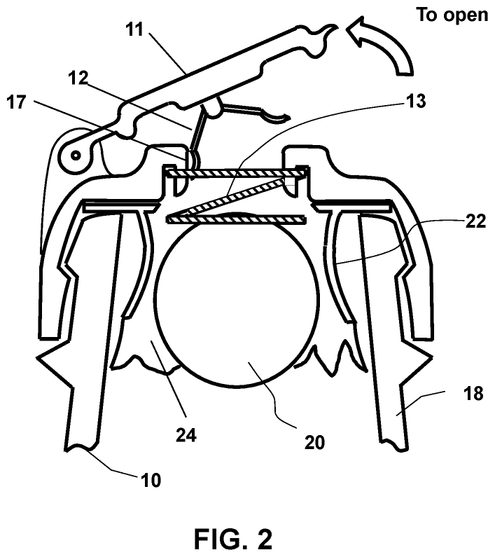

FIGS. 1 and 2 illustrate an exemplary embodiment of marble-sealed container 1. In some embodiments, marble-sealed container 1 comprises bottle 10 and cap 14. In some instances, cap 14 is constructed with an attached rotatable lid 11. In some embodiments, lid 11 rotates about eyelet 15 mounted on cap 14 in order to move between a closed position as shown in FIG. 1 and an open position as shown in FIG. 2.

Still referring to FIG. 1, marble-sealed container 1 can comprise marble 20 positioned within neck 18 of bottle 10. In some embodiments, marble 20 is held within neck 18 of bottle 10 below cap 14 and above the level of a liquid in marble-sealed container 1 by a flexible flange(s) 22. In some embodiments, flexible flange(s) 22 extend(s) from a base portion that is positioned between an upper edge of neck 18 and cap 14. In some embodiments, flange(s) 22 can be integral with neck 18, cap 14, or lid 11. In some embodiments, flange(s) 22 can have a curved shape that compliments the shape of marble 20.

In some embodiments, non-dissolvable membrane 24 surrounds or at least partially surrounds marble 20 along the lower edge of flexible flange(s) 22 to protect marble 20 from the liquid within bottle 10. In at least some embodiments, non-dissolvable membrane 24 acts as a barrier to prevent an exposed surface of marble 20 from the liquid contained in marble-sealed container 1.

In some embodiments, cap 14 can include spring 13 to propel marble 20 through flange(s) 22. In some embodiments, cap 14 or neck 18 can include annular ring 16 that extends downwardly from a circular opening 17 in cap 14 above marble 20. In some embodiments, spring 13 is positioned about annular ring 16 and is retained in a compressed state by a flexible detent 12 that is secured to an underside of lid 11 when lid 11 is in the closed position.

Turning now to FIG. 2, an opening mechanism of marble-sealed container 1 is illustrated. In some embodiments, in order to open marble-sealed container 1, a user applies pressure in an upward direction to a point at or near the edge of lid 11 opposite of eyelet 15, causing lid 11 to rotate about eyelet 15. In some instances, the pressure of a user's thumb of a hand that holds bottle 10 provides enough pressure to complete an opening motion, which allows for a one-hand operation. As pressure is applied to lid 11, lid 11 moves away from circular opening 17, detent 12 moving with lid 11 and releasing spring 13 from the compressed state. In some embodiments, spring 13 extends into an uncompressed state and pushes down marble 20. In some embodiments, the pressure of marble 20 overcomes the pressure of flange(s) 22 and breaks membrane 24. In some embodiments, as marble 20 breaks membrane 24, marble 20 passes through flexible flange(s) 22 and releases into the liquid that fills marble-sealed container 1. Removal of marble 20 from cap 14 provides an opening to allow the liquid to be poured out of marble-sealed container 1.

Referring again to FIG. 1, bottle 10 in combination with lid 11, cap 14, marble 20, flexible flange(s) 22, and non-dissolvable membrane 24 produces a liquid-tight seal that prevents the liquid in container from spilling out while also providing an opening mechanism, which allows a user to easily open cap 14 using a single hand.

In at least some embodiments, bottle 10 is configured to store a liquid, such as but not limited to a beverage. In some embodiments, marble-sealed containers are not limited for use with beverages. For example, in some embodiments, bottle 10 can be used to store cleaning products.

In some embodiments, marble 20 is made of glass, plastic, metal, edible materials, or combinations thereof. In some embodiments, marble 20 is solid. In some embodiments, marble 20 is made of a soluble material. In some embodiments, marble 20 is at least partially, if not fully, soluble.

Still referring to FIG. 1, as briefly discussed above, marble 20 can comprise a soluble material. In some such embodiments wherein marble 20 comprises a soluble material, membrane 24 is non-dissolvable.

As briefly mentioned above, in some embodiments, as the marble gradually comes into contact with the liquid held in marble-sealed container 1, marble 20 can partially, if not completely dissolve, depending on whether marble 20 contains liquid-soluble materials or non-soluble materials. In some embodiments, a dissolvable marble 20 offers a variety of advantages. For example, when marble 20 begins dissolving upon contact with the liquid as marble-sealed container 1 opens, marble 20 no longer impedes pouring or drinking from marble-sealed container 1. Second, the novelty of the dissolving marble 20 can be appealing and entertaining to users. For example in some embodiments, marble 20 can dissolve and display a color effect in the drink content. Alternatively, or in addition to, marble 20 can dissolve to release additional ingredients into the beverage. In an example, the marble can dissolve to release flavors, colors, vitamins, minerals, and/or other nutrients.

In some embodiments, marble-sealed container 1 can be closed by lowering rotatable lid 11 down up to the point where it forms a watertight seal with cap 14.

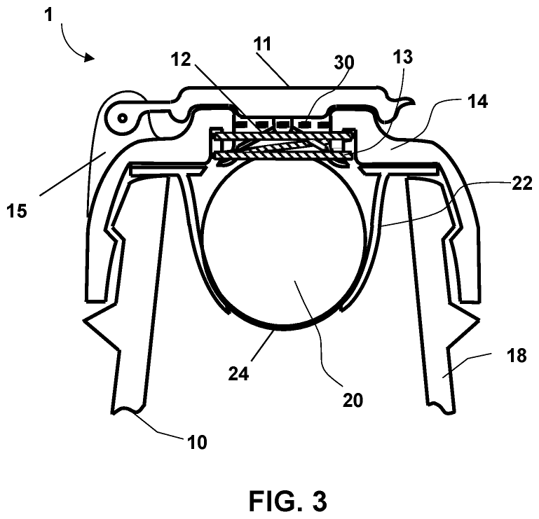

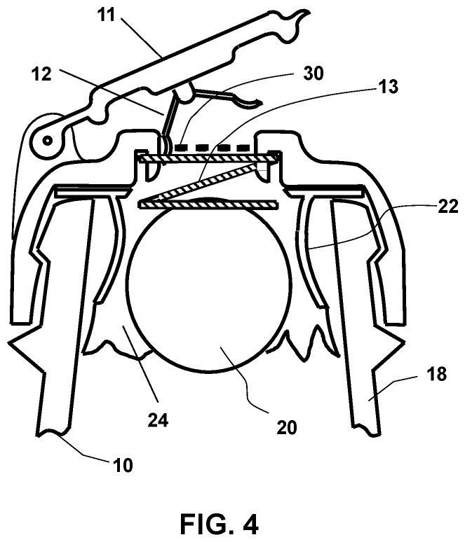

Turning to FIG. 3, an embodiment of a marble-sealed container 1 that includes grid 30 is shown. In some embodiments, grid 30 is configured to prevent marble 20 from escaping marble-sealed container 1. In some embodiments, grid 30 is fixed in the container. In some embodiments, grid 30 can be moved in the container. In some embodiments, grid 30 can be integrated with spring 13. In some embodiments, grid 30 can be constructed as a part of cap 14, flexible detent 12, flexible flange(s) 22, or as a separate feature, as illustrated in FIGS. 3 and 4. In some embodiments, grid 30 can comprise a portion of the design of spring 13. In some embodiments, grid 30 can comprise fabric, plastic, metal, and/or other suitable material(s).

In some embodiments, a mobile application allows users to engage with a product and/or business associated with the product. In some embodiments, the mobile application can, among other things, track the progress of the marble dissolution, track the change in intensity of the color and/or flavor change in the drink after opening, explore the ball drop effect, and/or combinations thereof. In some embodiments, the mobile application can include social media features, gaining features, and/or product promotion features.

In some embodiments, the mobile application can be activated by a user action on a user interface of a computer device (e.g., mobile phone, tablet, laptop, smartwatch, etc.).

In some embodiments, the mobile application can be activated by opening the product (e.g., bottle, can, container, packaging). In some embodiments, this can be achieved by embedding a wireless transmitter into the product that is programmed to transmit a specified signal upon the user opening the product. For example, in some embodiments, a transmitter can be embedded into a bottle cap. In some embodiments, the transmitter can be embedded into other parts of the product packaging such as, but not limited to, the neck of a bottle, the body of a bottle, the body of the can, the lid of a can, a rigid container, a flexible container, a box, a pouch, a pull tab mounted on a can, and/or protective materials such as film, foil, and/or other wrapping materials used in the packaging.

In some embodiments, the mobile application can include features that allows a business entity, such as, but not limited to, one that manufactures and/or distributes the product to gather information about the product users. In some embodiments, such information can include, but is not limited to, the geographical location(s) of the user(s), date(s) and/or time(s) the product was used, and/or date(s) and/or time(s) the mobile application was used.

In some embodiments, the mobile application can collect and transmit the data associated with the actions taken by the product users. In some embodiments, this data can include, but is not limited to, the feature(s) of the mobile application the product user(s) have engaged with, advertisements or promotional content the product user(s) choose to watch and/or interact with, user(s) device IDs, IP addresses(es), and/or data collected and stored by cookies located on device(s) of the user(s).

In some embodiments, the mobile application can obtain data identifying the product user(s), and/or data identifying the individual(s) connected to the product user(s) via social networks and/or other software applications. In some embodiments, the mobile application can transmit data identifying the product user(s), and/or data identifying the individual(s) connected to the product user(s) via social networks and/or other software applications.

In some embodiments, aspects of the systems and methods described herein can be controlled by one or more controllers. In some embodiments, one or more controllers can be adapted to run a variety of application programs, access and store data, including accessing and storing data in the associated databases, and/or enable one or more interactions as described herein. In at least some embodiments, the controller is implemented by one or more programmable data processing devices. In some embodiments, the hardware elements, operating systems, and/or programming languages of such devices are conventional in nature.

For example, in some embodiments, the controller(s) can be a PC based implementation of a central control processing system utilizing a central processing unit (CPU), memory and an interconnect bus. In some embodiments, the CPU can contain a single microprocessor. In some embodiments, the CPU can contain a plurality of microprocessors for configuring the CPU as a multi-processor system.

In some embodiments, the memory can include a main memory, such as a dynamic random access memory (DRAM) and cache, as well as a read only memory, such as a programmable read-only memory (PROM), erasable programmable read only memory (EPROM), FLASH-EPROM, or the like. In some embodiments, the system can include form(s) of volatile and/or non-volatile memory. In some embodiments of operation, the memory stores at least portions of instructions for execution by the CPU and data for processing in accord with the executed instructions.

In some embodiments, the controller(s) can also include one or more input/output interfaces for communications with one or more processing systems. In some embodiments, one or more such interfaces can enable communications via a network, for example, to enable sending and receiving instructions electronically. The communication links can be wired or wireless.

In some embodiments, the controller(s) can include appropriate input/output ports for interconnection with one or more output mechanisms, such as but not limited to, monitors, printers, touchscreens, motion-sensing input devices, etc. and/or one or more input mechanisms, such as but not limited to, keyboards, mice, voice, touchscreens, bioelectric devices, magnetic readers, radio-frequency identification (RFID) readers, barcode readers, motion-sensing input devices, etc. serving as one or more user interfaces for the controller. For example, in some embodiments, the controller(s) can include a graphics subsystem to drive the output mechanism. In some embodiments, the links of the peripherals to the system can be wired connections and/or use wireless communications.

Although summarized above as a personal computer (PC)-type implementation for ease of explanation, the controller(s) can also encompass(es) systems such as, but not limited to, host computers, servers, workstations, network terminals, and the like. In some embodiments, the controller(s) can be embodied in a device, such as a mobile electronic device, like a smartphone or tablet computer. The use of the term controller is intended to represent a broad category of components known in the art.

Hence aspects of the systems and methods provided herein encompass hardware and software for controlling the relevant functions. Software can take the form of code or executable instructions for causing a controller or other programmable equipment to perform the relevant steps, where the code or instructions are carried by or otherwise embodied in a medium readable by the controller or other machine. Instructions or code for implementing such operations can be in the form of computer instruction in any form (e.g., source code, object code, interpreted code, etc.) stored in or carried by any tangible readable medium.

As used herein, terms such as computer or machine “readable medium” refer to mediums that participate in providing instructions to a processor for execution. Such mediums can take many forms. Non-volatile storage media include, but are not limited to, optical or magnetic disks, such as storage devices in computers. Volatile storage media can include dynamic memory, such as the memory of such a computer platform. Common forms of computer-readable media therefore can include for example: a floppy disk, a flexible disk, hard disk, magnetic tape, other magnetic medium, a CD-ROM, DVD, other optical medium, punch cards paper tape, other physical medium with patterns of holes, a RAM, a PROM and EPROM, a FLASH-EPROM, other memory chip or cartridge, or other medium from which a controller can read programming code and/or data. Many of these forms of computer readable media can be involved in carrying one or more sequences of one or more instructions to a processor for execution.

It should be noted that various changes and modifications to the embodiments described herein will be apparent to those skilled in the art. Such changes and modifications can be made without departing from the spirit and scope of the present invention and without diminishing its attendant advantages. For example, various embodiments of the systems and methods can be provided based on various combinations of the features and functions from the subject matter provided herein.

What is claimed is:

1. A container comprising:
a container body including a container neck with an opening;
a lid connected to said container body at said opening, wherein said lid is configured to move between an open position and a closed position;
at least one flexible flange positioned within said container neck;
a marble positioned in said container neck within said at least one flexible flange, wherein said at least one flexible flange prevents movement of said marble;
a spring positioned inside said container neck above said marble, wherein said spring moves between a compressed state and an uncompressed state; and
a flexible detent attached to an underside of said lid, wherein said flexible detent is configured to retain said spring in said compressed state, and
wherein, when said lid moves from said closed position to said open position, said flexible detent releases said spring to said uncompressed state.

2. The container of claim 1, wherein said container contains a liquid.

3. The container of claim 2, wherein a non-dissolvable membrane extends from the lower edge of said at least one flexible flange below said marble.

4. The container of claim 2, wherein at least a portion of said marble is dissolvable in said liquid stored in said container body.

5. The container of claim 4, wherein upon said marble dissolving, said liquid changes color.

6. The container of claim 4, wherein upon said marble dissolving, said liquid changes flavor.

7. The container of claim 4, wherein upon said marble dissolving, nutrients are released into said liquid.

8. The container of claim 1, further comprising a movable grid positioned above said marble and below said lid, wherein said movable grid prevents removal of said marble from said container.

9. The container of claim 1, further comprising a fixed grid positioned above said marble and below said lid, wherein said fixed grid prevents removal of said marble from said container.

10. A container comprising:
a container body including a neck, wherein said neck includes an opening for dispensing content stored within said container;
a cap attached to said neck, said cap including a lid rotatable about an eyelet, wherein said lid is configured to move between an open position and a closed position;
an at least one flexible flange extending downwardly from said opening in said neck;
a marble positioned within said at least one flexible flange, wherein said at least one flexible flange prevents movement of said marble;
a spring positioned inside said cap above said marble,
a flexible detent positioned on an underside of said lid and configured to retain said spring in a compressed state when said lid is in said closed position; and
wherein, when said lid moves into said open position, said flexible detent releases said spring into an uncompressed state.

11. The container of claim 10, wherein said content of said container comprises a liquid.

12. The container of claim 11, wherein at least a portion of said marble is dissolvable in said liquid stored in said container body.

13. The container of claim 11, wherein said at least one flexible flange is a circular flange.

14. The container of claim 10, further comprising a movable grid positioned above said marble and below said lid, wherein said movable grid prevents removal of said marble from said container.

15. The container of claim 10, further comprising a fixed grid positioned above said marble and below said lid, wherein said fixed grid prevents removal of said marble from said container.

16. The container of claim 11, wherein a non-dissolvable membrane extends from the lower edge of said at least one flexible flange below said marble.

17. The container of claim 12, wherein upon said marble dissolving, said liquid changes color.

18. The container of claim 12, wherein upon said marble dissolving, said liquid changes flavor.

19. The container of claim 12, wherein upon said marble dissolving, nutrients are released into said liquid.

20. The container of claim 1, wherein said at least one flexible flange is a circular flange.
